(19) United States
(12) Patent Application Publication
(10) Pub. No.: US 2018/0037321 A1
(43) Pub. Date: Feb. 8, 2018

(54) LAW ENFORCEMENT DRONE

(71) Applicant: Christopher Wilkinson, Brooklyn, NY (US)

(72) Inventor: Christopher Wilkinson, Brooklyn, NY (US)

(21) Appl. No.: 15/670,100

(22) Filed: Aug. 7, 2017

Related U.S. Application Data
(60) Provisional application No. 62/371,412, filed on Aug. 5, 2016.

(51) Int. Cl. B64C 39/02; F41H 13/00; G01S 7/38; F41H 3/00

(52) U.S. Cl. CPC B64C 39/024; F41H 3/00; F41H 13/0012; G01S 7/38; B64C 2201/046; B64C 2201/048; B64C 2201/126; B64C 2201/123; B64C 2201/127; B64C 2201/146; B64C 2201/22

(57) ABSTRACT

A law enforcement drone system is provided. The system features an unmanned aerial vehicle, having a wireless transceiver, an airframe, a propulsion system, a navigation mechanism, a processor, a memory, a power source, and at least one fuel tank. The system also features a control system having a wireless transceiver, an input device, capable of receiving a user's input and converting the user's input to electrical signals, a processor, and a memory. The control system is in wireless communication with the vehicle such that the control system is capable of utilizing the propulsion system in substantially real-time.

### CLAIM OF PRIORITY

This application claims the priority of U.S. Ser. No. 62/371,412 filed on Aug. 5, 2016, the contents of which are fully incorporated herein by reference.

### FIELD OF THE EMBODIMENTS

The invention and its embodiments relate to an unmanned aerial vehicle (“drone”), in particular a stealth drone that has been optimized for tracking a suspect's location as well as determining, from a database, information salient to the suspect's capture.

### BACKGROUND OF THE EMBODIMENTS

Tensions between the police and citizens are at an all-time high. Struggling to do their job effectively, police are in dire need of help to do job, especially help that will allow them to do their job while complying with the laws they swore to uphold. However, with the development of the microprocessor and its related technologies, new machines are available that are capable of performing more and more of these unsavory tasks.

Chief among these machines is the unmanned aerial vehicle (“UAV”). These vehicles are either fixed-wing aircraft or rotorcraft that is capable of being operated from a remote location. Frequently, these vehicles lack the capability of housing a human pilot. This provides a number of benefits, such as increased fuel efficiency, maximum range, maneuverability, and flexibility in design. These UAV's are commonly used for surveillance, military operations, or for recreational use. In all three of these applications, the UAV is equipped with surveillance equipment, be it a standard camera, wide-angled video recorder, or some military-grade observation technologies.

The last of these categories is of particular interest, as humanity grows increasingly reliant on wireless communications. However, as this reliance increases, as do the security measures surrounding these transmissions. As such, there exists a need for a UAV that is capable of covertly disabling communications.

Further, these sensors can include infrared scanners and thermal imaging sensors, providing operators with views not accessible by the human eye. In addition to providing and disrupting communications, technologies exist that allow UAV's to deliver electromagnetic pulses, used to disable target electronics. These targets can include buildings and automobiles.

As such, there is a need for a UAV that is capable of tracking, monitoring, and pinpointing criminal activity, communicate with one or more police stations; have an invisibility cloak, be capable of readily downloading blueprints and other information about various buildings and automobiles; have a wide array of sensors, and be capable of generating an electromagnetic pulse.

Review of Related Technology:

U.S. Patent Publication No.: 2009/0212157 pertains to a flying micro-rotorcraft unit is provided for remote tactical and operational missions. The unit includes an elongated body having an upper and a lower end. The body defines a vertical axis. The unit further includes a navigation module including means for determining a global position of the elongated body during flight of the unit. Rotor means of the unit is coupled to the upper end of the elongated body for generating a thrust force that acts in a direction parallel to the vertical axis to lift the elongated body into the air. The rotor means is located between the elongated body and the navigation module.

U.S. Patent Publication No.: 2014/0254896 pertains to a system and method for delivering mail and goods using a mobile robot drone system. The method may comprise self-moving the mobile robot drone system to a mail or goods receiving location. Data on the mail or goods receiving location and mail or goods to deliver id received from a user. Itinerary to the mail or goods receiving location is determined based on itinerary data received from a GPS unit. In the location, the mobile robot drone system receives the mail or goods via a mail and goods compartment and then delivers the mail or goods to a predefined location. Based on user instructions, the mobile robot drone system electronically signs receipt verification documents or performs payment by displaying a payment barcode encoding user payment information. After delivering the mail or goods, the mobile robot drone system provides access to the mail and goods compartment.

U.S. Patent Publication No.: 2010/0279649 pertains to a System of Components for Improvement in Citizens, Law Enforcement Personnel Protection, and Property, Security and Overall Crime Reduction through Criminal Apprehension Success Rates. A Remote Sheriff Controlled Video Remote Controlled Law Enforcement Response and Video Evidence Documenting Improvements including Deputy Audio/Video Camera Forehead Mounted and Selective Force Weapons Mounted on Miniature Drone Aircraft and Helicopters for Low Speed Surveillance or High Speed Chase, also used for Business or. Police Station Roof Top Mounted Decoy and Live Drone Hangers or Telescoping Equipment for Squad Car and Private Security. Also Permanent Public Roadway Mounted Equipment including Stop Stick deployment control also Home or Business Security System Instant interconnected and 911 System Audio/Video Emergency Caller Instant Interconnected with Improved Cell Phone Telephoto Lens Capable and Instant 911 Interconnection with Family Members Cell Phone Location Finder and Home Security Camera Concealment Equipment and Marine Cellular Mapping Devices.

U.S. Patent Publication No.: 2013/0182118 pertains to a method for performing video surveillance of a mobile unit in a wireless network is provided. A wireless network receives a surveillance request for a mobile unit. The surveillance request comes from a law enforcement agency and includes the identity of the mobile unit and a geographical area. The wireless network determines that the mobile unit has entered the geographical area and sends the geographical location of the mobile unit from the wireless network to the law enforcement agency.

U.S. Patent Publication No.: 2005/0051667 pertains to a flying micro-rotorcraft unit is provided for remote tactical and operational missions. The unit includes an elongated body having an upper and a lower end. The body defines a vertical axis. The unit further includes a navigation module including means for determining a global position of the elongated body during flight of the unit. Rotor means of the unit is coupled to the upper end of the elongated body for generating a thrust force that acts in a direction parallel to the vertical axis to lift the elongated body into the air. The rotor means is located between the elongated body and the navigation module.

Foreign Patent Document No.: CN204737042 pertains to a UAV disperse means, including carrier, camera., speaker and bright LED lights, fixed on a support with an integrated housing, camera, speaker and bright LED lights are permanently installed in the integrated cabinet side, the bottom of the box integration with a bomb device. The utility model at the same time equipped with a camera, speakers, bright LED lights and bomb equipment, cameras for video images, the speaker can be used as a loudspeaker propaganda use, but also can play noise, bright LED lamp for emitting light, cause human discomfort, bomb device can be put tear gas to disperse the crowd so. The utility model provides a versatile means to disperse, disperse to achieve accurate, reducing the use of police to reduce the risk of enforcement officers.

Foreign Patent Document No.: CN202102301 pertains to a super long-range unmanned aerial vehicle control system based on a civil mobile phone network, which is formed by an airborne system and a ground system. The airborne system is composed of a communication and navigation subsystem and an attitude control subsystem. The communication and navigation subsystem completes mobile phone communication, automatic navigation and task functions, the attitude control subsystem completes attitude and speed control of an unmanned aerial vehicle, the ground system achieves manually or automatically sending out control instruction which is received by the attitude control subsystem so as to achieve take-off and landing control and work mode conversion of the unmanned aerial vehicle. The super long-range unmanned aerial vehicle control system adopts the mobile phone network to achieve the super long-range control of the unmanned aerial vehicle, overcomes the shortcomings that a corresponding control device in the existing technology of the unmanned aerial vehicle is large in volume, heavy in weight, large in power consumption and strong in electromagnetic radiation, obtains distributed control based on data and instruction transmission of the mobile phone network, can be widely applied to many fields of forest fire prevention, surveying and mapping, exploration, aerial photography and videography, disaster reduction and disaster relief, enforcement and supervision, emergency command and the like.

Foreign Patent Document No.: CN203573114 pertains to a police unmanned aerial vehicle wireless controller integrates the unmanned aerial vehicle remote transmitter and the video receiving display equipment on the controller, the operator controls the motion of the unmanned aerial vehicle and the airborne equipment through the rockers, and the images sent back by the unmanned aerial vehicle can be displayed in real time through the liquid crystal display screen.

Foreign Patent Document No.: CN204822083 pertains to a multipurpose military police investigation in a variety of mission requirements, explosion, rescue, widely used, with strong promotional value.

Foreign Patent Document No.: CN202795060 pertains to a 3G police unmanned aerial vehicle management and control system, comprising a flight unit and a ground measurement and control unit. The flight unit comprises an unmanned aerial vehicle flight platform and an intelligent control apparatus for controlling the flight of the unmanned aerial vehicle flight platform; the unmanned aerial vehicle flight platform comprises a central body, a plurality of power apparatuses arranged at the periphery of the outer end of the central body and a camera module arranged on the central body; the ground measurement and control unit comprises an information reception portion, an information process portion and a 3G video transmission module; both the information reception portion and the 3G video transmission module are electrically connected with the information process portion; the information reception portion and the 3G video transmission module of the ground measurement and control unit are respectively communicated with the unmanned aerial vehicle flight platform and the police 3G mobile video monitor and command system of the flight unit. According to the utility model, air/ground integrated 3G mobile video monitor and command are realized, the prior police work requirement s satisfied, the police affair process efficiency and accident monitor and process efficiency are increased.

Various devices are known in the art. However, their structure and means of operation are substantially different from the present invention. Such devices fail to provide a device that is optimized for non-infant children, fail to enhance the child's imagination, which is capable of being used as a nap retraining device. At least one embodiment of this invention is presented in the drawings below, and will be described in more detail herein.

### SUMMARY OF THE EMBODIMENTS

The present invention provides for a law enforcement drone system, comprising: an unmanned aerial vehicle, comprising: a wireless transceiver, an airframe, a propulsion system, a navigation mechanism, a processor, a memory, a power source, at least one fuel tank; a control system, comprising: a wireless transceiver, an input device, capable of receiving a user's input and converting said user's input to electrical signals, a processor, a memory, wherein said memory contains at least one computer program executable by said processor, said at least one computer program being capable of interpreting said electrical signals and transmitting corresponding instructions to said propulsion system via said wireless transceiver, a power supply, wherein said control system is in wireless communication with said vehicle such that said control system is capable of utilizing said propulsion system of said vehicle in substantially real-time. In some embodiments, the propulsion system comprises at least one rocket or jet engine. In other embodiments, the at least one rocket or jet engine can be complimentarily reoriented to direct the motion of said vehicle, wherein said reorientation is performed via at least one motor rotating at least one arm.

In many embodiments, the vehicle is wrapped in a cloaking mechanism. This cloaking mechanism may project the appearance of outer space or it may blend the external temperature of the vehicle with an area immediately surrounding the vehicle. In a majority of embodiments, the law enforcement drone features a payload. In some embodiments, this payload is at least one sensor selected from the group consisting of: electro-optical/infrared sensors, hyperspectral imaging sensors, LIDAR, DIAL, SAR, video recorders, and cameras. In other embodiments the payload is an electromagnetic wave generator.

In still other embodiments, the payload is a conducted electrical weapon, said control system is housed in an automobile, or said vehicle further comprises a radio frequency jamming mechanism. Preferably, said vehicle is capable of transmitting a signal within a predetermined frequency range and said wireless transceiver is retractable into said airframe. Also preferably, said payload is retractable into said airframe.

The present invention also contemplates a method of disrupting satellite communications comprising: deploying, from the stratosphere, a vehicle, comprising: a wireless transceiver, an airframe, a propulsion system, a navigation mechanism, a processor, a memory, a power source, a cloaking mechanism, and a payload; operating, said vehicle via a control station, comprising: a power source, a memory, a processor, and a control mechanism, guiding, said vehicle into the thermosphere; transmitting, via said wireless transceiver of said vehicle, a transmission within a predetermined radio frequency range for a pre-determined amount of time. Preferably, in this step of operating, the vehicle, via a control station, is performed by a human operator.

It is an object of the present invention to provide a system that is capable of interrupting enemy communications.

It is an object of the present invention to provide a system that is capable of disabling a satellite.

It is an object of the present invention to provide an unmanned aerial vehicle suitable for law enforcement situations.

It is an object of the present invention to provide a means to operate an unmanned aerial vehicle remotely.

It is an object of the present invention to provide an unmanned aerial vehicle capable of blending into its surroundings.

It is an object of the present invention to provide an unmanned aerial vehicle that cannot be detected by a machine.

It is an object of the present invention to provide a means to aid law enforcement.

### BRIEF DESCRIPTION OF THE DRAWINGS

FIG. 1 shows a top perspective view of an embodiment of the present invention in a fully-retracted position.

FIG. 2 shows a perspective view of an embodiment of the present invention patrolling a city.

FIG. 3 shows a top view of an embodiment of the present invention, scanning a building for a specific person.

### DESCRIPTION OF THE PREFERRED EMBODIMENTS

The preferred embodiments of the present invention will now be described with reference to the drawings. identical elements in the various figures are identified with the same reference numerals.

Reference will now be made in detail to each embodiment of the present invention. Such embodiments are provided by way of explanation of the present invention, which is not intended to be limited thereto. in fact, those of ordinary skill in the art may appreciate upon reading the present specification and viewing the present drawings that various modifications and variations can be made thereto.

While this disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

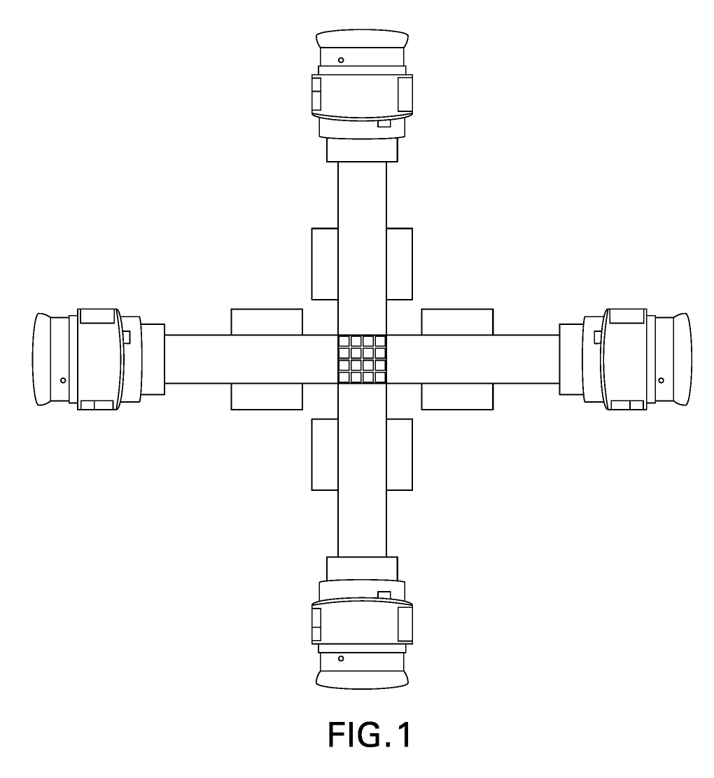

FIG. 1 shows a top perspective view of an embodiment of the present invention in a fully-retracted position. Here, the law enforcement drone is equipped with propulsion system, and airframe. While airframe resembles an octagon here, because vehicle is intended to operate in the earth's atmosphere, the principles of aerodynamics need not be adhered to due to the low density of the air that exists in the stratosphere. Further, there are many suitable mechanisms that can power propulsion system, such as, but not limited to, ramjet, rocket propulsion, afterburners, propellers, turbines, and fans. Many modern commercial aircraft prioritize high engine efficiency and low fuel usage, while military aircraft focus on having excess thrust so that they can achieve high acceleration and help overcome the drag that occurs at high-speeds. As such, in many preferred embodiments of the present invention, propulsion system will be capable of creating large amounts of thrust very quickly, despite the fact that less drag will occur at the present invention's optimized operating altitude.

The present invention also features a variety of sensors, including a front camera, a back camera, at least two side cameras, an infrared camera, a thermal energy sensor, a plurality of tracking monitors, and a computer, which operates as a central data command. These sensors are used individually or in conjunction to help identify and track the location of a suspect, as well as to allow the law enforcement drone to have a sufficient field of vision to be operated remotely. The integrated computer will preferably house blueprints of all major makes and models of automobiles, as well as blueprint information of buildings within a certain area. Preferably, this area will correspond to the jurisdictional limits of the police force utilizing the law enforcement drone. Preferably, the law enforcement drone will be equipped with a cloaking mechanism. This may operate, either by displaying an image of space to anyone below the drone, or to cover the law enforcement drone with panels that are capable of masking the law enforcement drone's thermal signature.

Further, the law enforcement drone of the present invention is capable of generating an electromagnetic pulse. Due to shielding on the outside of the law enforcement drone, the electromagnetic pulse will not affect the computer f the law enforcement drone. This electromagnetic pulse will be able to disable the electronic systems of a suspect.

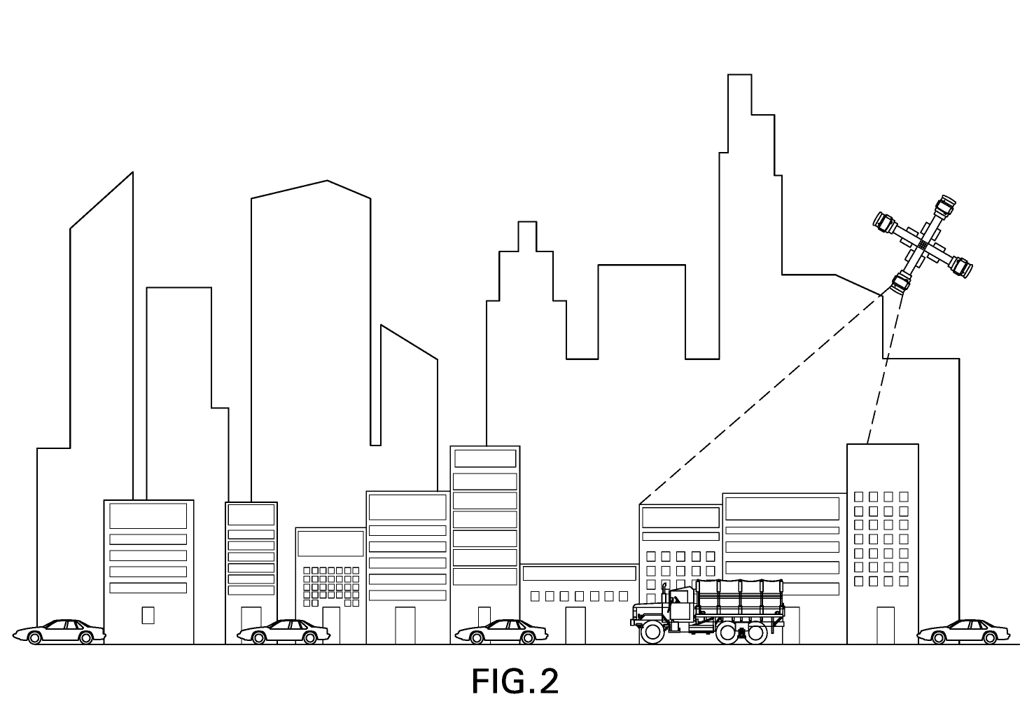

FIG. 2 shows an embodiment of the law enforcement drone patrolling a city. The law enforcement drone will be capable of flying at high altitudes, as well as low altitudes. For example, the law enforcement drone will be capable of flying between buildings in a city, but will also be able to be in the low-earth atmosphere to monitor from a distance.

Preferably, the present invention is equipped with a wireless transceiver. This wireless transceiver may double as radio frequency jammer. This can be achieved by broadcasting a strong signal at the same frequency that an enemy is communicating on, or may be achieved by transmitting static, or some other predetermined sound across a wide range of frequencies.

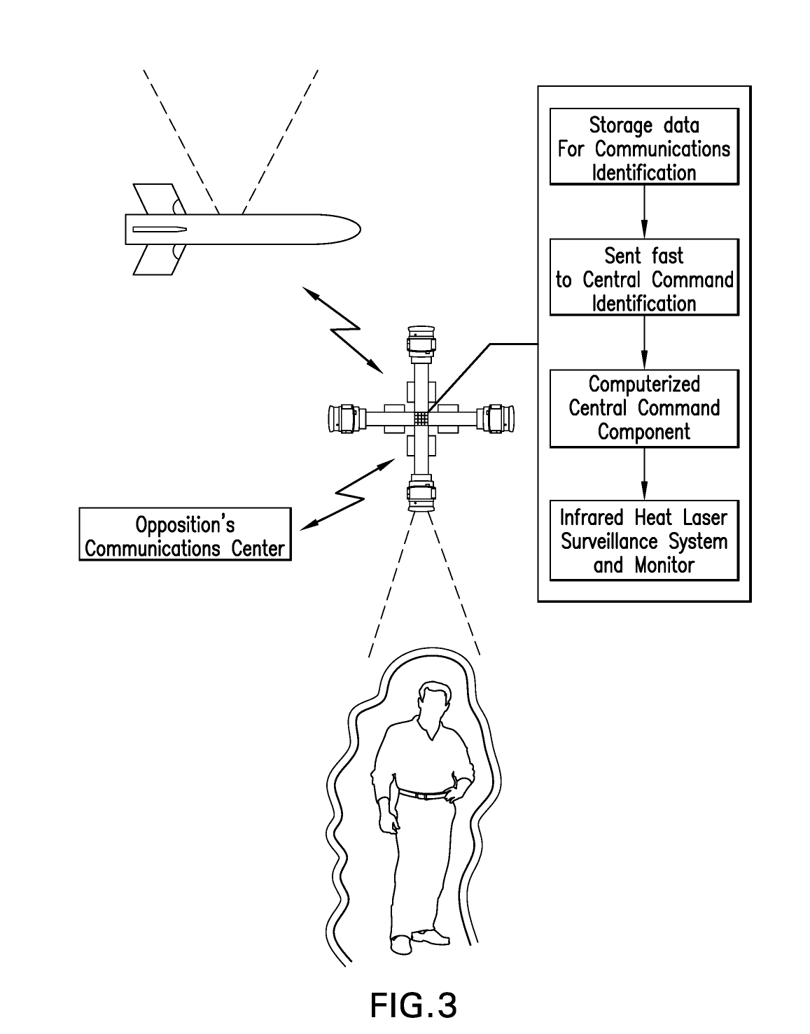

FIG. 3 shows a top view of an embodiment of the present invention, illustrating the rotatable nature of the at least one source of propulsion. The rotatable nature of the propulsion system allows the law enforcement drone to navigate freely in 3-dimensional space. In a preferred embodiment, the propulsion system is comprised of 4 rocket-powered engines, however, embodiments with two or more engines are also contemplated by the present invention. In the depicted embodiment, the law enforcement drone will use the on-board processor and memory, coupled with an integrated GPS system to move the law enforcement drone through Cartesian space. By adjusting the thrust and angle of the propulsion system in a complementary fashion, the law enforcement drone will be able to move freely across any Cartesian axis. This provides for an incredibly high level of maneuverability, which is in part made possible by the lower levels of gravity and air density that exist in the Earth's upper atmosphere. That said, the law enforcement drone is also possible of operating as low as 400 ft above the ground.

In a preferred embodiment, the server of the present invention is comprised of at least one memory unit and at least one processor, and handles the computational processing of the law enforcement drone. The at least one fuel tank typically holds rocket fuel, but is capable of storing any fluid that is suitable for use with the propulsion system of the present invention.

The law enforcement drone of the present invention is intended to be operated remotely. The control station can be in an automobile, in a building on earth, or from an aircraft near the law enforcement drone.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Therefore, it is intended that the disclosure not be limited to the particular embodiments disclosed.

What is claimed is:

1. A law enforcement drone system, comprising:
an unmanned aerial vehicle, comprising:
a wireless transceiver,
an airframe,
a propulsion system,
a navigation mechanism,
a processor,
a memory,
a power source,
at least one fuel tank;
a control system, comprising:
a wireless transceiver,
an input device, capable of receiving a user's input and converting said user's input to electrical signals,
a processor,
a memory,
wherein said memory contains at least one computer program executable by said processor,
said at least one computer program being capable of interpreting said electrical signals and transmitting corresponding instructions to said propulsion system via said wireless transceiver,
a power supply,
wherein said control system is in wireless communication with said vehicle such that said control system is capable of utilizing said propulsion system of said vehicle in substantially real-time.

2. The law enforcement drone system of claim 1, wherein said propulsion system comprises at least one rocket or jet engine.

3. The law enforcement drone system of claim 2, wherein said at least one rocket or jet engine can be complimentarily reoriented to direct the motion of said vehicle,
wherein said reorientation is performed via at least one motor rotating at least one arm.

4. The law enforcement drone system of claim 1, where said vehicle is wrapped in a cloaking mechanism.

5. The law enforcement drone system of claim 4, wherein said cloaking mechanism projects the appearance of outer space.

6. The law enforcement drone system of claim 4, wherein said cloaking mechanism blends the external temperature of the vehicle with an area immediately surrounding the vehicle.

7. The law enforcement drone system of claim 1, further comprising a payload.

8. The law enforcement drone system of claim 7, wherein said payload is at least one sensor selected from the group consisting of: electro-optical/infrared sensors, hyperspectral imaging sensors, LIDAR, DIAL, SAR, video recorders, and cameras.

9. The law enforcement drone system of claim 7, wherein the payload is an electromagnetic wave generator.

10. The law enforcement drone system of claim 7, wherein the payload is a conducted electrical weapon.

11. The law enforcement drone system of claim 1, wherein said control system is housed in an automobile.

12. The law enforcement drone system of claim 1, wherein said vehicle further comprises a radio frequency jamming mechanism.

13. The law enforcement drone system of claim 1, wherein said vehicle is capable of transmitting a signal within a predetermined frequency range.

14. The law enforcement drone system of claim 1, wherein said wireless transceiver is retractable into said airframe.

15. The law enforcement drone system of claim 7, wherein said payload is retractable into said airframe.

16. The law enforcement drone system of claim 11, wherein said control system is capable on controlling the retracting of said payload, as well as the operation of said payload.
